(19) United States
(12) Patent Application Publication
(10) Pub. No.: US 2018/0343362 A1
(43) Pub. Date: Nov. 29, 2018

(54) IMAGE PROCESSING APPARATUS AND CONTROL METHOD

(71) Applicants: KABUSHIKI KAISHA TOSHIBA, Tokyo (JP); TOSHIBA TEC KABUSHIKI KAISHA, Tokyo (JP)

(72) Inventor: Yoshihito HIROE, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/699,061

(22) Filed: Sep. 8, 2017

(30) Foreign Application Priority Data
May 24, 2017 (JP) 2017-102995

(51) Int. Cl. H04N 1/60; G06K 9/46; G06K 9/62; H04N 9/68

(52) U.S. Cl. CPC H04N 1/6008; H04N 9/68; G06K 9/6212; G06K 9/46

(57) ABSTRACT

An acquisition section acquires image data indicating a document. A storage section stores characteristics of a plurality of colors containing a predetermined color. A classifying section classifies a pixel contained in the image data acquired by the acquisition section based on the characteristics of the color stored in the storage section. A deriving section derives a statistic relating to the number of pixels classified into pixels of the predetermined color by the classifying section. A generation section generates new image data obtained by correcting the predetermined color in the image data when it is determined that an image is formed with the predetermined color on the document based on the statistic derived by the deriving section.

### CROSS-REFERENCE TO RELATED APPLICATION

This application is based upon and claims the benefit of priority from Japanese Patent Application No. 2017-102995, filed May 24, 2017, the entire contents of which are incorporated herein by reference.

### FIELD

Embodiments described herein relate generally to an image processing apparatus and a control method.

### BACKGROUND

In a case of copying, there is an image processing apparatus which determines whether a document is chromatic or monochrome, and corrects image data based on a determination result. In such an image processing apparatus, it is impossible to correct the image data acquired from the document on which an image is formed in a predetermined color which is developed with a color material different from cyan, magenta, yellow and black.

### DESCRIPTION OF THE DRAWINGS

FIG. 1 is a block diagram illustrating an image processing apparatus according to an embodiment;

FIG. 2 is a flowchart illustrating the flow of a processing by the image processing apparatus;

FIG. 3 is a diagram illustrating a ground determination area of a ground color determination target pixel;

FIG. 4 is a diagram illustrating distribution of a value of a signal in a case in which a color material is not contained;

FIG. 5 is a diagram illustrating distribution of the value of the signal in a case in which the color material is not contained;

FIG. 6 is a diagram illustrating R2;

FIG. 7 is a diagram illustrating G2;

FIG. 8 is a diagram illustrating B2;

FIG. 9 is a diagram illustrating the characteristics of cyan;

FIG. 10 is a diagram illustrating the characteristics of magenta;

FIG. 11 is a diagram illustrating the characteristics of yellow;

FIG. 12 is a diagram illustrating the characteristics of black;

FIG. 13 is a diagram illustrating the characteristics of blue;

FIG. 14 is a diagram (cyan) illustrating the characteristics due to a luminosity value;

FIG. 15 is a diagram (blue) illustrating the characteristics due to a luminosity value;

FIG. 16 is a diagram illustrating a reference data structure in consideration of the luminosity value as well; and

FIG. 17 is a flowchart illustrating the flow of a classification processing of one pixel.

### DETAILED DESCRIPTION

In accordance with an embodiment, an image processing apparatus comprises an acquisition section, a storage section, a classifying section, a deriving section and a generation section. The acquisition section acquires image data indicating a document. The storage section stores characteristics of a plurality of colors containing a predetermined color. The classifying section classifies a pixel contained in the image data acquired by the acquisition section based on the characteristics of the color stored in the storage section. The deriving section derives a statistic relating to the number of pixels classified into pixels of the predetermined color by the classifying section. The generation section generates new image data obtained by correcting the predetermined color in the image data in a case in which it is determined that an image is formed with the predetermined color on the document based on the statistic derived by the deriving section.

In an image processing apparatus of an embodiment, it is possible to support the image processing apparatus capable of correcting image data acquired from a document on which an image is formed in a predetermined color. Hereinafter, the image processing apparatus of the embodiment is described in detail.

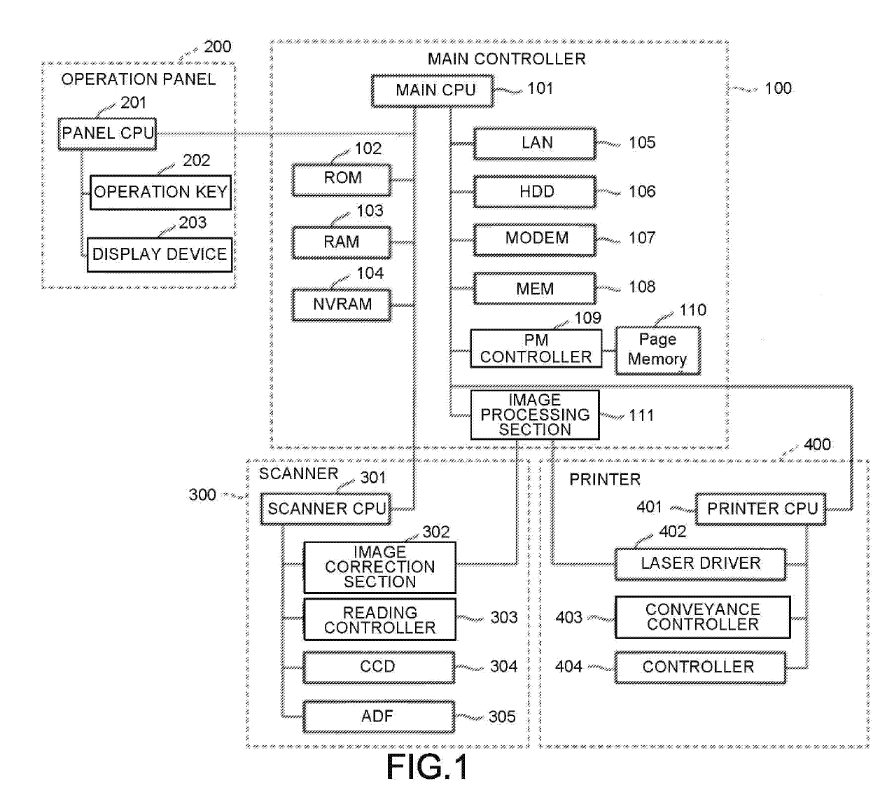

FIG. 1 is a block diagram illustrating the arrangement of an image processing apparatus 1 according to the embodiment. In FIG. 1, the image processing apparatus 1 includes a main controller 100, an operation panel 200, a scanner 300 and a printer 400. The image processing apparatus 1 includes a main CPU 101 in a main controller 100, a panel CPU 201 of an operation panel 200, a scanner CPU 301 of a scanner 300, and a printer CPU 401 of the printer 400.

The main controller 100 includes a main CPU 101, a ROM 102, a RAM 103, an NVRAM 104, a network controller 105, an HDD 106, a modem 107, an MEM 108, a PM (page memory) controller 109, a page memory 110, and an image processing section 111.

The main CPU 101 controls the overall operation of the image processing apparatus 1. A control program is stored in the ROM 102. The RAM 103 temporarily stores data. The NVRAM 104 is a nonvolatile memory and holds data even if the power is cut off.

The network controller 105 connects with the image processing apparatus 1 and the network. The image processing apparatus 1 can be connected to an external device such as a server or a PC (Personal Computer) via the network controller 105. The HDD 106 stores image data. The image data stored in the HDD 106 includes data read by the scanner 300 and image data (document data, drawing image data, etc.) from the PC. The image data is compressed and stored. The modem 107 connects with the image processing apparatus 1 and a telephone line. The MEM 108 is a main memory of the main controller 100.

The page memory 110 can store the image data from the scanner 300 for each page. The page memory 110 can store the image data for a plurality of pages. A page memory controller 109 controls the page memory 110. The image processing section 111 stores and reads the image data in and from the page memory 110 by the page memory controller 109. As a result, the image processing section 111 executes a color conversion processing, a range correction processing, a sharpness adjustment processing, a gamma correction and halftone processing, and a pulse width modulation processing.

In any processing, a processing is executed according to parameters set by the main CPU 101. The main CPU 101 refers to an adjustment value indicating a setting content set by the operation panel 203 and reads appropriate parameters from the ROM 102 to set them. If the document types (chromatic, monochrome, blue color) are different, the parameters relating to the image processing are different.

The image processing section 111 executes the color conversion processing, the range correction processing, the sharpness adjustment processing, the gamma correction and halftone processing and the pulse width modulation (PMW) processing. For example, the range correction processing is an edge emphasis processing for emphasizing a change point of the image for the purpose of making a line drawing part easier to see, and a processing for widening a density difference between the ground and the character part. The sharpness adjustment processing is used for adjusting a contour outline of the image. In the gamma correction and halftone processing, a gamma correction taking into consideration the characteristics of an output device of the printer 400 is executed. In a gamma correction and halftone processing section, a processing for expressing an intermediate color is executed by performing dithering or the like. In the PWM (pulse width modulation) processing, a pulse width and a pulse position are adjusted in order to form required gradations (plural gradations) according to the image data on a photoconductive drum. The image data on which the image processing is executed is output to the printer 400. The printer 400 prints an image according to the image data on the sheet.

In the present embodiment, the functions of the image processing section 111 are realized by an ASIC (Application Specific Integrated Circuit), and the processing executed by the image processing section 111 may be realized by hardware.

The operation panel 200 has the panel CPU 201, operation keys 202, and a display device 203. The panel CPU 201 controls the operation panel 200. The panel CPU 201 is connected to the main CPU 101. The operation keys 202 include a numeric keypad for instructing the number of copies to be printed. The display device 203 has functions of a liquid crystal and a touch panel. The user can execute various instructions and settings such as a sheet size, a print magnification, an image quality adjustment and the like with the display section 203.

The scanner 300 has the scanner CPU 301, an image correction section 302, a reading controller 303, a CCD (Charge Coupled Device) 304, and an ADF (Auto Document Feeder) 305. The scanner CPU 301 controls the scanner 300. The reading controller 303 controls the CCD 304 by a CCD driver (not shown). The CCD 304 reads a document and outputs analog signals of R, G and B indicating the document. The image correction section 302 includes an A/D conversion circuit, a shading correction circuit, a line memory, and the like. Among them, the A/D conversion circuit converts the analog signals of R, G and B output from the CCD 304 into digital signals, respectively. The ADF 305 is an automatic document conveyance section.

The printer 400 has the printer CPU 401, a laser driver 402, a conveyance controller 403, and a controller 404. The printer CPU 401 controls the printer 400. The laser driver 402 drives a laser. The conveyance controller 403 conveys the sheet. The controller 404 controls a charging device, a developing device, a transfer device and the like (none is shown).

In the arrangement described above, the image processing apparatus 1 according to the present embodiment generates anew image data in which the predetermined color is corrected. In the present embodiment, explanation is made by using the color developed by a decolorable color material (decoloring toner) as an example of the predetermined color. The decoloring toner is a decolorable recording agent. The decoloring toner has a color developing density lower than that of a black toner. The decoloring toner develops a color at a temperature lower than a predetermined value to become visible, and is decolorized at a temperature equal to or higher than the predetermined value to be invisible. The decoloring toner is blue color and is formed on the sheet. Accordingly, the color developed by the decoloring toner develops is blue. In the following description, first, a processing outline is described using a flowchart, and then the detail of each processing is described. A document on which an image is formed with the decoloring toner is referred to as a blue document in some cases.

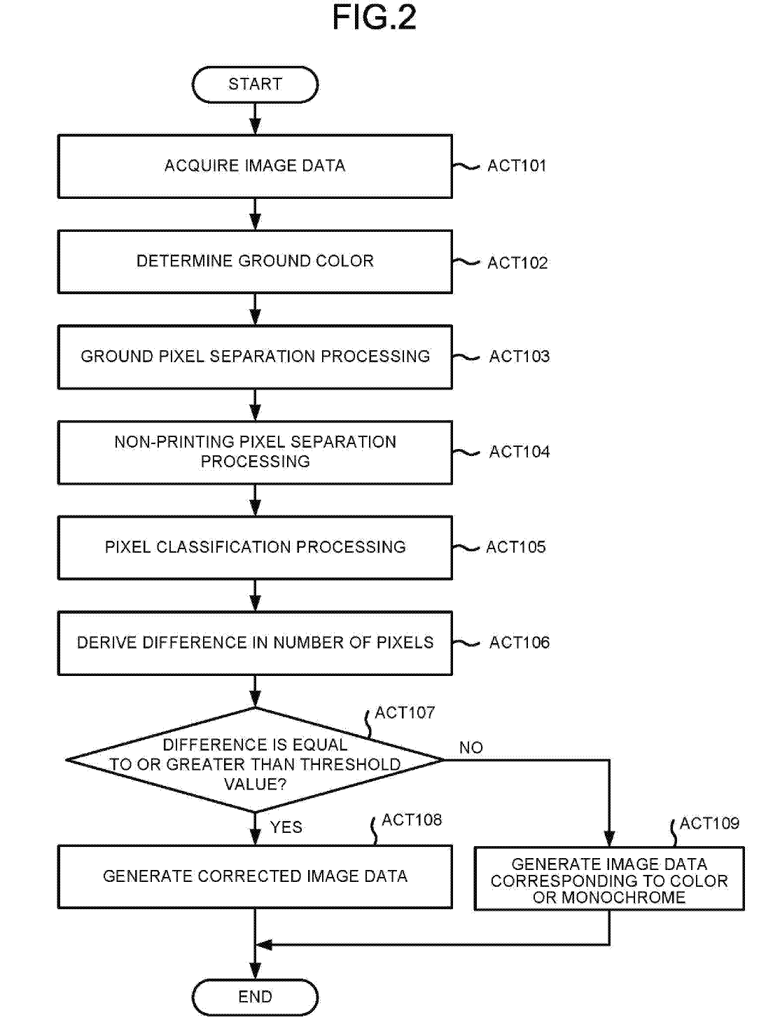

FIG. 2 is a flowchart illustrating the flow of a processing by the image processing apparatus 1. The scanner 300 reads the document to acquire the image data indicating the document (ACT 101). The image processing section 111 determines the ground color of the document from the acquired image data (ACT 102). The image processing section 111 executes a ground pixel separation processing for separating a pixel indicating the ground color of the document among the pixels of the image data (ACT 103). This is because there is no need to determine colors as there is only the decoloring toner and no or little color material in the pixels having the same color as the ground color of the document. By the ground pixel separation processing, it is possible to reduce pixels which are the color classification objects, and thus it is possible to execute the processing at a high speed. By the processing in ACT 103, pixels showing a color different from the ground color of the document are separated as pixels which are the color classification objects.

The image processing section 111 further executes a non-printing pixel separation processing among the pixels separated as pixels which are the color classification objects by the processing in ACT 103 (ACT 104). The non-printing pixel is a pixel which is different from the ground color of the document but does not contain much color material. The non-printing pixel is greatly influenced by the ground color. By the processing in ACT 104, the pixel which is greatly influenced by the ground color of the document is separated as the pixel which is the color classification object. By the non-printing pixel separation processing, since it is possible to reduce pixels which are the color classification objects, the processing can be executed at a high speed. An erroneous determination of the color can be suppressed by separating pixels which is greatly influenced by the ground color of the document.

In the present embodiment, the pixels which are the color classification objects are gradually narrowed down by the processing in ACT 103 and ACT 104. The image processing section 111 classifies the pixels separated as pixels which are the color classification objects by the processing in ACT 104 (ACT 105). In the present embodiment, the pixels are classified by six colors: cyan, magenta, yellow, black, blue, and others. In addition, the “blue” is a color that the aforementioned decoloring toner develops. The “others” are colors other than cyan, magenta, yellow, black, and blue. By the classification, the number of pixels classified into each of the six colors can be obtained.

The image processing section 111 derives a difference in the number of pixels obtained by the processing in ACT 106 (ACT 106). The difference in the number of pixels is a difference between the number of pixels classified as blue and the number of pixels classified as colors other than blue. Therefore, five kinds of differences (blue and cyan, blue and magenta, blue and yellow, blue and black, blue and others) are derived. In the present embodiment, a minimum value among the five kinds of differences is compared with a threshold value, and if the minimum value is equal to or larger than the threshold value, it is determined that an image is formed in blue on the document. If the number of pixels of blue is sufficiently larger than the number of other pixels, it is determined that an image is formed on the document with the decoloring toner.

The image processing section 111 determines whether or not the difference is greater than or equal to the threshold value (ACT 107). If the difference is greater than or equal to the threshold value (YES in ACT 107), the image processing section 111 generates the corrected image data (ACT 108) and ends the present processing. If the difference is less than the threshold value (NO in ACT 107), the image processing section 111 generates the image data corresponding to the document (chromatic or monochrome) which is not a blue document (ACT 109), and ends the present processing. The printer 400 forms an image based on the image data generated by the processing in ACT 108 and ACT 109.

The correction in ACT 108 is described. As described above, the decoloring toner has the lower color developing density than the non-decoloring recording agent such as the black toner. Therefore, the image data obtained from the blue document by the scanner 300 shows a thin image compared with the image data acquired by the scanner 300 from a monochrome document. Therefore, if the same processing as the image processing for the image data acquired by the scanner 300 from the monochrome document is executed, the thin image is formed. Therefore, in ACT 108, in order to improve the visibility of the color formed on the sheet, the correction processing for enhancing the image read from the blue document is executed. As an example of the correction processing for emphasis, a correction processing for forming an image read from the blue document in black and a correction processing for forming an image with dark blue can be exemplified.

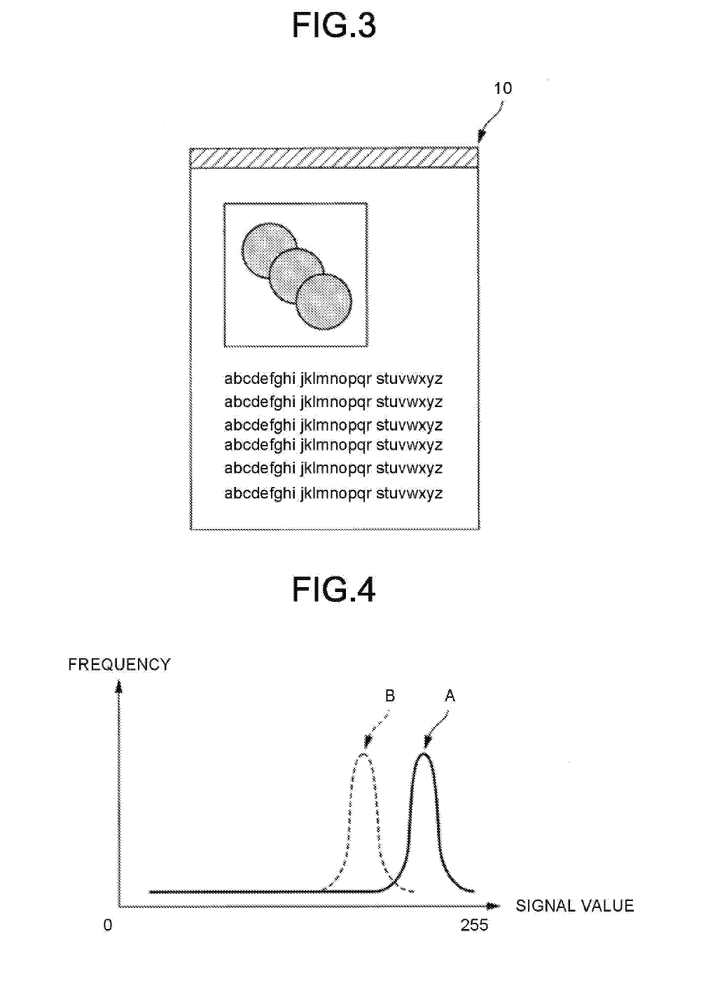

Next, the ground color determination described above in ACT 102 is described. First, in the present embodiment, a part of pixels of the image data indicating the document is set as a ground color determination target pixel. FIG. 3 is a diagram illustrating a ground determination area of the ground color determination target pixel. In the example in FIG. 3, the pixel of an area 10 of several millimeters from the tip of the document is the ground color determination target pixel. The oblique lines in the area 10 are drawn for easy understanding, and are actually plain. In general, an edge of the document is often plain, and thus it is suitably used as an area for determining the ground color of the document. Not limited to the edge of the document, pixels in other areas may be the ground color determination target pixels, and a size of the ground determination area may be arbitrarily determined. In the case of the document that is printed up to the edge of the document, the larger determination area is preferable.

If the color determination area does not contain the color material, the distribution of a signal value of the ground color determination target pixel has one peak value. FIG. 4 is a diagram illustrating the distribution of the signal value if the color material is not included in the ground determination area. In the present embodiment, the signal value of the pixel takes is 0˜255. FIG. 4 shows a frequency of the signal value of R (red) as an example output by the scanner 300. In FIG. 4, two peaks A and B are shown as an example, but the peak A shows the distribution if the document is a light color and the peak B shows the distribution if the document is a dark color. In any case, if the color determination area does not contain the color material, the distribution of the signal value of the ground color determination target pixel has one peak value. The image processing section 111 calculates the distribution in each of the RGB, and acquires the peak values thereof. Then, the image processing section 111 determines the ground color as a color having signal values of peak values of the RGB.

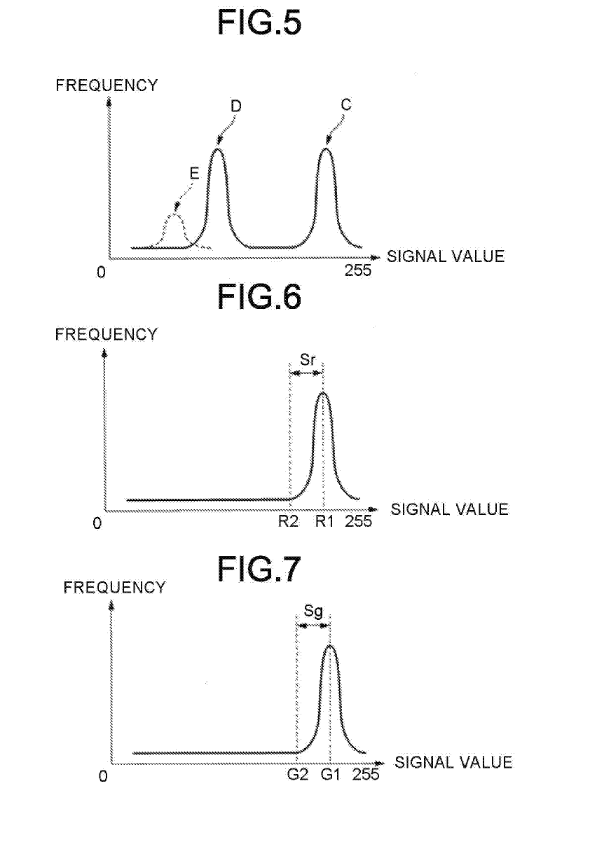

On the other hand, if the color determination area contains the color material, the distribution of the signal value of the ground color determination target pixel has a plurality of peak values. FIG. 5 is a diagram illustrating the distribution of the signal value if the color material is included in the ground determination area. FIG. 5 also shows the frequency of signal values of R as an example. Among the peak values shown in FIG. 5, the peak E indicates the peak value if a region other than the document is included in the ground determination area. As shown in FIG. 5, if the color determination area contains the color material, the distribution of the signal value of the ground color determination target pixel has multiple peaks C and D. In this way, if there is a plurality of peak values, a peak value having the largest signal value is set as the signal value of the ground color. This is because documents that are generally used are almost white and dark colors are hardly used in the documents. Therefore, in FIG. 5, the peak value of the ground color of R is the peak C. The image processing section 111 obtains the distribution in each of the RGB to acquire the peak values thereof. Then, the image processing section 111 determines the ground color as a color having signal values of the peak values of the RGB.

The signal values of the RGB of the ground color determined by the ground color determination described above are R1, G1, and B1, respectively. Using the R1, G1 and B1, the image processing section 111 executes the ground pixel separation processing in ACT 103. In the case in which the pixel contains the color material, the signal values of the RGB of that pixel are smaller than R1, G1, and B1, respectively. Therefore, by setting reference for determining the pixel containing the color material as R1, G1 and B1, it is conceivable to determine a pixel having a signal value smaller than the reference as a pixel including the color material. However, as shown in FIGS. 4 and 5, since the pixel value of the ground is included in the vicinity of the peak value, a signal value smaller than R1, G1 and B1 is used as a reference and a pixel having the signal value smaller than the reference value is preferable.

Therefore, the image processing section 111 derives R2, G2, B2 newly as shown in FIGS. 6, 7, and 8. R2, G2, B2 are derived as follows by using constants Sr, Sg and Sb.

R2=R1−Sr,G2=G1−Sg,B2=B1−Sb

The constants Sr, Sg and Sb are determined depending on the scanner 300, specifications of and the color material and how much the pixel is narrowed; however, the constants Sr, Sg and Sb may depend on a standard deviation S. The standard deviation S here is the standard deviation of the distribution of the signal value of each of the RGB.

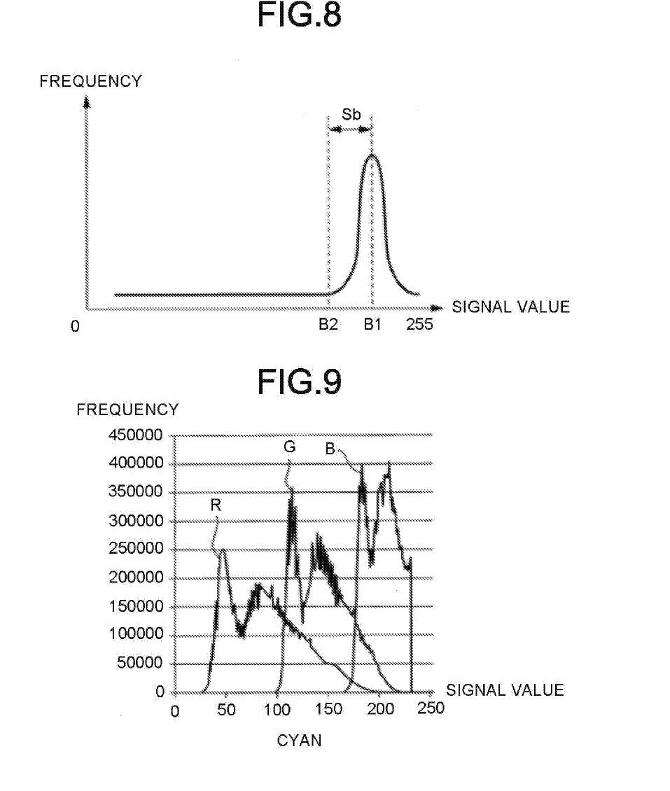

The image processing section 111 separates a pixel satisfying all of r≤R2, g≤G2, and b≤B2 as the pixel that is not the ground if the signal value of R of the pixel is set to r, the signal value of G is set to g, and the signal value of B is set to b. As a result, as shown in FIG. 6, FIG. 7, and FIG. 8, the pixel of the ground can be eliminated.

If the pixel satisfying all of r≤R2, g≤G2, and b≤B2 is a pixel which is the color classification object by the ground pixel separation processing in the ACT 103, the image processing section 111 executes the non-printing pixel separation processing in ACT 104. As described above, the non-printing pixel separation processing separates pixels largely affected by the ground color. In the present embodiment, “pixel largely affected by the ground color” is quantitatively determined as follows.

First, LA is derived as follows using R1, G1 and B1.

LA=δR1+εG1+ξB1

δ, ε and ζ are constants that satisfy δ+ε+ζ=1, for example, δ=0.3, ε=0.4, ζ=0.3.

The brightness La of the pixel is derived as follows using the signal values r, g and b of the pixel.

La=αr+βg+γb

α, β and γ are constants satisfying α+β+γ=1, for example, α=0.3, β=0.4, γ=0.3.

The image processing section 111 sets the pixel satisfying La<LA as the pixel which is the color classification object. This is a countermeasure against the fact that if the ground color is dark, the influence of the ground color on the image signal of the pixel becomes relatively large. In other words, if the ground color is dark, a threshold value LA is lowered, and if the paper color is thin, by setting the threshold value LA to a higher value, the pixel largely affected by the ground is classified.

The image processing section 111 executes a pixel classification processing in ACT 105 on these pixels if the pixels which are the color classification objects are narrowed by the non-printing pixel separation processing in the ACT 104. In the pixel classification processing, the pixels which are the color classification objects are classified based on the characteristics of a plurality of colors composed of cyan, magenta, yellow and black including blue by decoloring toner which are stored in the ROM 102.

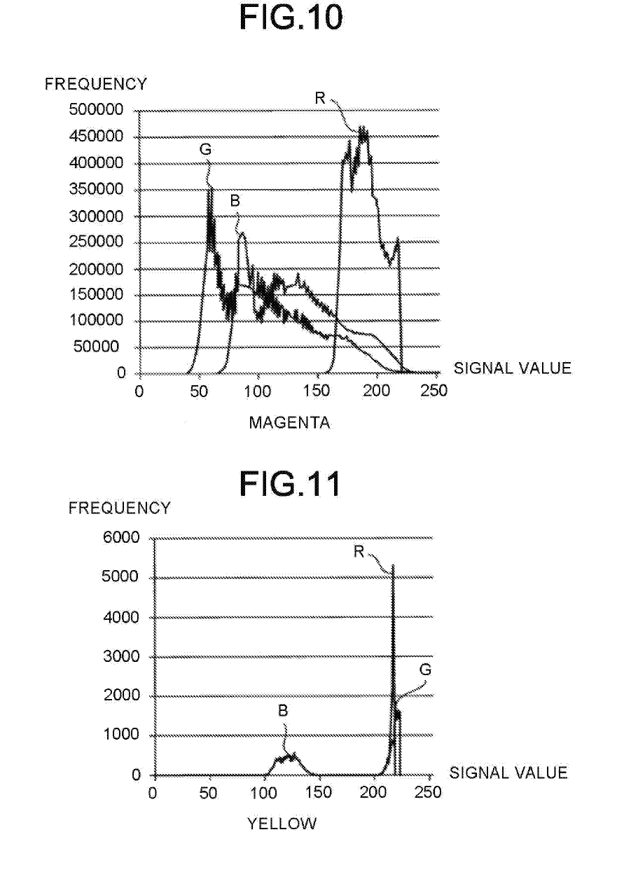

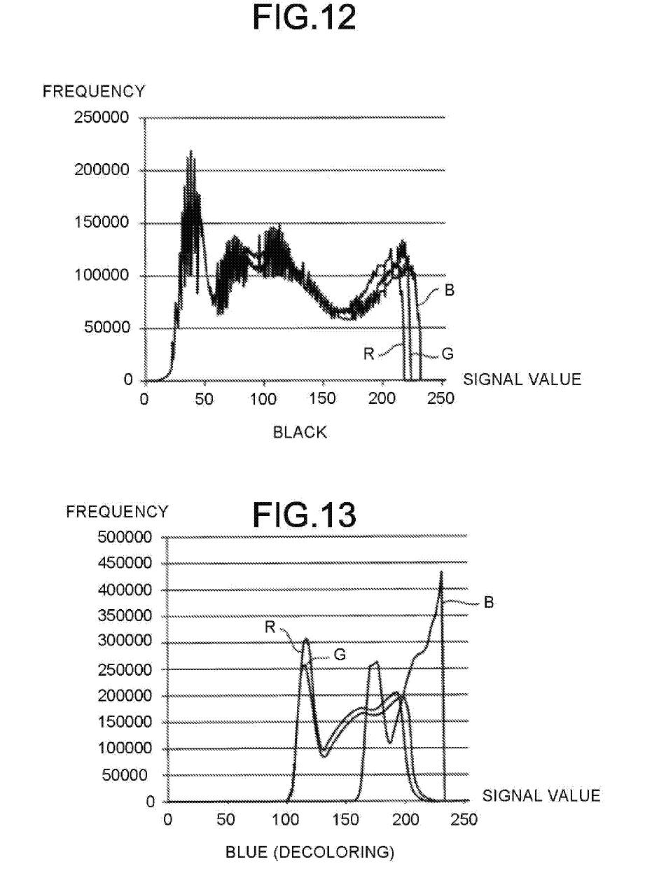

FIG. 9˜FIG. 13 are diagrams illustrating the characteristics of cyan, magenta, yellow, black and blue developed by the decoloring toner. Each figure shows the distribution of frequencies corresponding to signal values of the RGB obtained from a document in which each color is formed with a single color. The frequency of the signal value for the ground color of the document is excluded from any graph. FIG. 9 is a diagram illustrating the distribution of the RGB obtained from the document on which an image is formed only with the cyan. FIG. 10 is a diagram illustrating the distribution of the RGB obtained from the document on which an image is formed only with the magenta. FIG. 11 is a diagram illustrating the distribution of the RGB obtained from the document on which an image is formed only with the yellow. FIG. 12 is a diagram illustrating the distribution of the RGB obtained from the document on which an image is formed only with the black. FIG. 13 is a diagram illustrating the distribution of the RGB obtained from the document on which an image is formed only with the blue developed by the decoloring toner. It is shown that the characteristics are different for each color. As shown in FIG. 9˜FIG. 13, it is difficult to determine whether the color material of only one color is used or not, because the distribution range is wide in each figure.

Therefore, in the present embodiment, even if the same color is used, that the characteristics are different depending on the luminosity value is used. In the present embodiment, classification is executed by using the characteristics taking the luminosity value into account. Specifically, different references are set for each of RGB at the stages of a plurality of the luminosity values, and the pixels are classified according to the reference. In the present embodiment, the possible values of luminance are 0 to 255.

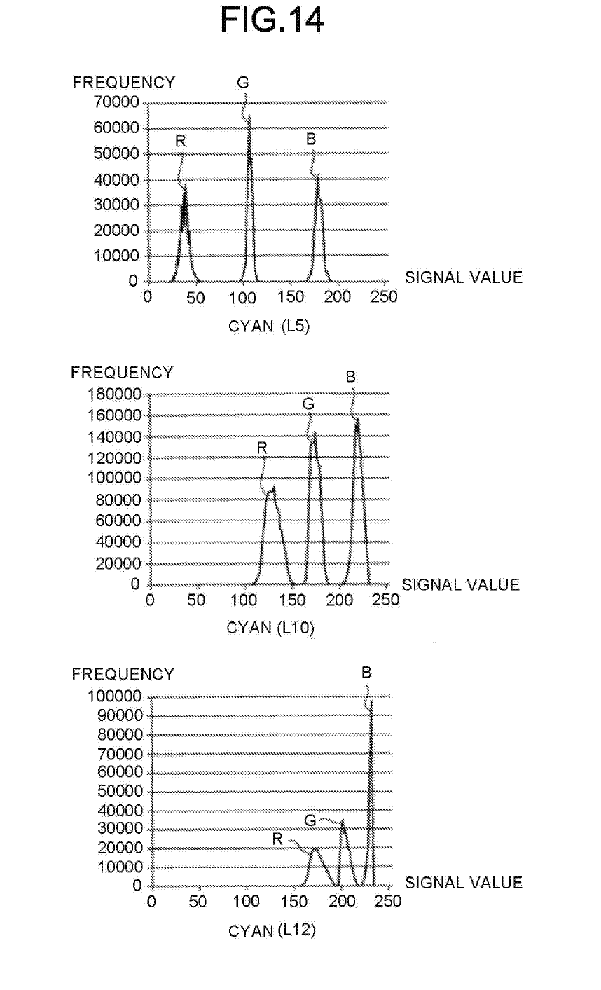

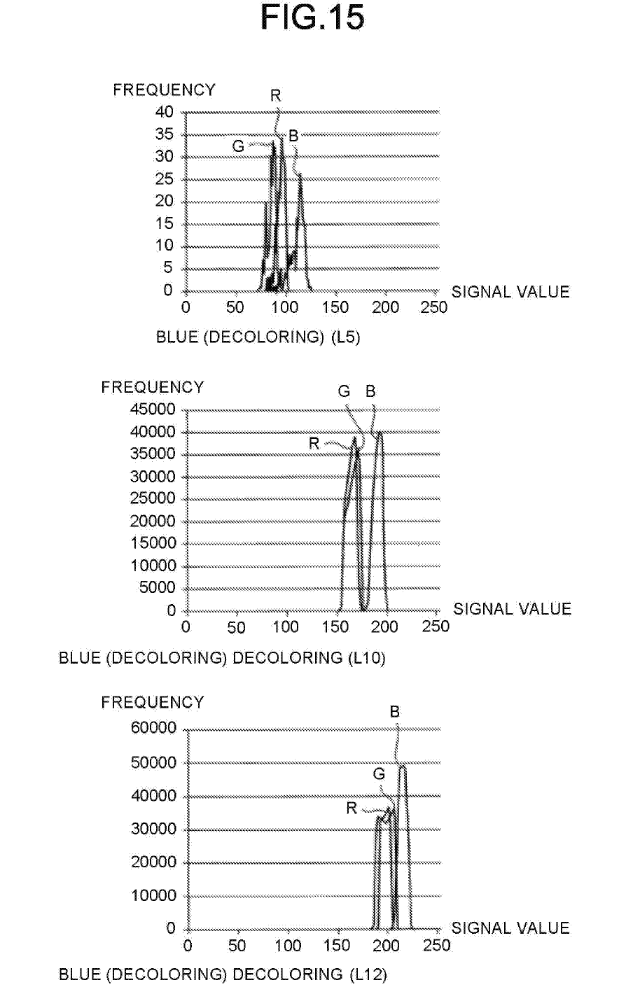

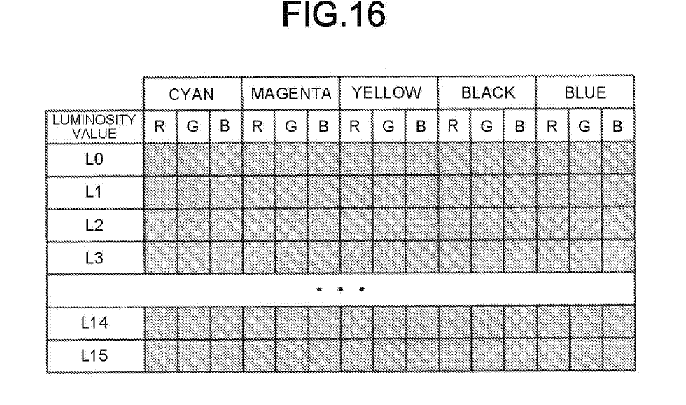

FIG. 14 and FIG. 15 are diagrams illustrating examples in which the characteristics are different due to the luminosity value. FIG. 14 is a diagram illustrating the characteristics of cyan if the luminosity value is in a range of each of L5, L10 and L12 described later. FIG. 15 is a diagram illustrating the characteristics of blue if the luminosity value is in a range of each of L5, L10 and L12.

In both cyan and blue, it is shown that the characteristics are different due to the luminosity value. Since the characteristics are different according to the luminosity value in this manner, in the present embodiment, it is possible to classify the pixels more accurately by setting a reference considering the luminosity value as well.

In the present embodiment, 0 to 255 which are possible values of the luminosity value is divided into 16 sections including L0˜L15. For the range of each section, if k is set as a suffix in L0˜L15, Lk indicates a range of the luminosity value L between 16 k and 16 k+15. For example, L0 indicates a range of 0˜15, and L15 indicates a range of 240˜255.

FIG. 16 shows the data structure of the reference considering the luminosity value. In the present embodiment, as shown in FIG. 16, references based on the characteristics of the RGB are provided for each of CMYK blue in each of L0˜L15. In the shaded area in FIG. 16, a range (upper limit value and lower limit value) as a reference is shown. For example, it is determined whether the luminosity value of the color classification object pixel is included in a certain Lj, the signal value r is included in the range of R indicated in the cyan of Lj, the signal value g is included in the range of G, and the signal values b is included in the range of B. If the signal values rgb of the pixel are all within the range of cyan of Lj, the pixel is classified as cyan.

As described above, in the present embodiment, the pixels are classified according to a total of 240 references with 16 kinds of the luminosity value, 5 types of CMYK and blue, and 3 types of RGB as references for classification.

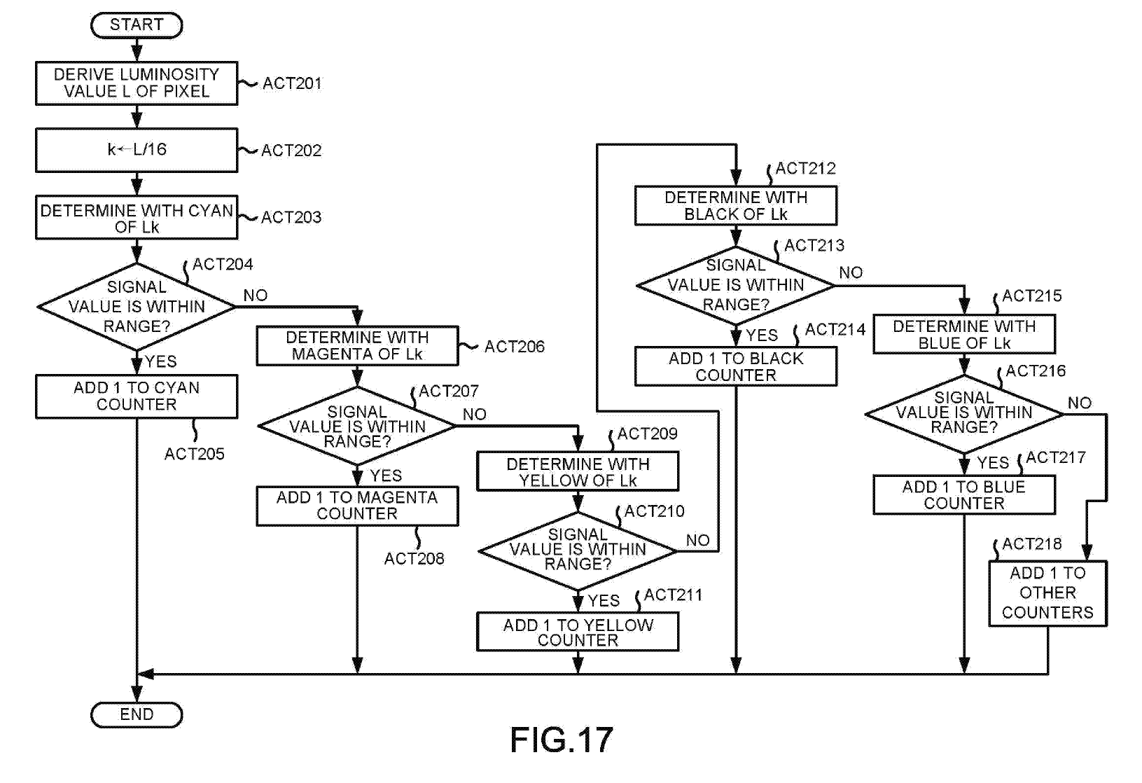

Based on these, the procedure of the pixel classification processing is described. FIG. 17 is a flowchart illustrating the flow of the classification processing for one pixel. The processing is used for classifying one pixel executed within the pixel classification processing in FIG. 2. Therefore, in the pixel classification processing in FIG. 2, the processing in FIG. 17 is repeated many times corresponding to the number of pixels classified. A cyan counter, magenta counter, yellow counter, black counter, blue counter, and other counters shown in FIG. 17 are counters for pixels classified as C, M, Y, K, blue, and “others”, and are initialized to 0 with the start of the pixel classification processing in FIG. 2.

The image processing section 111 derives the luminosity value L of the pixel which is the color classification pixel (ACT 201). The luminosity value L is derived, for example, by L=(76*r+151*g+28*b)/256 using the signal values rgb of the pixel. The method for deriving L is an example and a derivation method corresponding to the characteristics of the image processing apparatus (such as the characteristics of the scanner) may be used. The image processing section 111 substitutes a quotient obtained by dividing the luminosity value L by 16 into the suffix k (ACT 202). The image processing section 111 carries out determination based on the reference of cyan of Lk (ACT 203). The determination is made on whether or not the signal value r is included in the range of R indicated by cyan of Lk, the signal value g is included in the range of G, and the signal value b is within the range of B. If the signal values rgb of the pixel are all within the range of cyan of Lk (Yes in ACT 204), the image processing section 111 adds 1 to the cyan counter (ACT 205) and ends the present processing.

In ACT 204, if the signal values rgb of the pixel are not all within the range of cyan of Lk (No in ACT 204), the image processing section 111 carries out determination based on the reference of magenta of Lk (ACT 206). If the signal values rgb of the pixel are all within the range of magenta of Lk (Yes in ACT 207), the image processing section 111 adds 1 to the magenta counter (ACT 208) and ends the present processing.

In ACT 207, if the signal values rgb of the pixel are not within the range of magenta of Lk (No in ACT 207), the image processing section 111 carries out determination based on the reference of yellow of Lk (ACT 209). If the signal values rgb of the pixel are all within the range of yellow of Lk (Yes in ACT 210), the image processing section 111 adds 1 to the yellow counter (ACT 211) and ends the present processing.

In ACT 210, if the signal values rgb of the pixel are not within the range of yellow of Lk (No in ACT 210), the image processing section 111 carries out determination based on the reference of black of Lk (ACT 212). If the signal values rgb of the pixel are all within the range of black of Lk (Yes in ACT 213), the image processing section 111 adds 1 to the black counter (ACT 214) and ends the present processing.

In ACT 213, if the signal values rgb of the pixel are not within the range of black of Lk (No in ACT 213), the image processing section 111 carries out determination based on the reference of blue of Lk (ACT 215). If the signal values rgb of the pixel are all within the range of blue of Lk (Yes in ACT 216), the image processing section 111 adds 1 to the blue counter (ACT 217) and ends the present processing. On the other hand, if the signal values rgb of the pixel are not within the range of blue of Lk (No in ACT 216), the image processing section 111 adds 1 to the other counters (ACT 218) and ends the present processing.

If the above-described one-pixel classification processing is executed by the number of pixels which are the color classification objects, the number of pixels of each color is obtained by each counter. After that, the image processing section 111 generates the corrected new image data by executing the processing subsequent to ACT 106 in FIG. 2.

According to the image processing apparatus 1 of the embodiment described above, it is possible to provide the image processing apparatus capable of correcting the image data acquired from the document in which the image is formed with the predetermined color.

In the embodiment described above, as an example of the predetermined color, blue developed by the decoloring toner is used, but the present invention is not limited to this. The predetermined color may be any one of CMYK colors, or may be colors other than CMYK. As a color other than CMYK, for example, the predetermined color may be a color having a low color density such as a color of a highlighter drawn on a document. For example, in the case of the highlighter, the characteristics of the highlighter (the range of RGB for each luminosity value as shown in FIG. 16) are acquired from the document in which the image is drawn with the highlighter beforehand to be stored in the ROM 102. In this way, even if the color of the highlighter is taken as the predetermined color, the above-described embodiment can be applied as it is.

In the embodiment described above, the image processing section 111 generates the image data for forming the image in the printer 400 with the predetermined color, but it is not limited thereto. For example, the image data for display on the display device 203 may be generated. As the correction processing in this case, a correction processing for forming an image read from a blue document in black and a correction processing for forming an image with dark blue are exemplified.

In the above embodiment, the image processing section 111 uses the difference as the statistic, but it is not limited to this. For example, a ratio may be used. Specifically, a ratio (number of pixels classified as colors other than blue/number of pixels classified as blue) of the number of pixels is a ratio of the number of pixels classified as blue to the number of pixels classified as colors other than blue. Therefore, five ratios (blue and cyan, blue and magenta, blue and yellow, blue and black, blue and others) are derived. In the present embodiment, the maximum value among the five ratios is compared with a threshold value, and if the maximum value is equal to or less than the threshold value, it is determined that an image is formed in blue on the document. In other words, if the number of pixels of blue is sufficiently larger than the number of other pixels, it is determined that the image is formed with the decoloring toner on the document.

Another ratio may be the number of pixels classified as blue/the number of pixels which are color classification objects. It is the ratio of the number of pixels classified as blue to the whole. Also in this case, if the ratio is equal to or greater than a threshold value, it may be determined that the image is formed in blue on the document.

The functions of the image processing apparatus according to the foregoing embodiment may be realized by a computer. In this case, programs for realizing the functions are recorded in a computer-readable recording medium and the programs recorded in the recording medium may be read into a computer system to be executed. Further, it is assumed that the “computer system” described herein contains an OS or hardware such as peripheral devices. Further, the “computer-readable recording medium” refers to a portable medium such as a flexible disc, a magneto-optical disk, a ROM, a CD-ROM and the like or a storage device such as a hard disk built in the computer system. Furthermore, the “computer-readable recording medium” refers to a medium for dynamically holding the programs for a short time like a communication wire in a case in which the programs are sent via a communication line such as a network like the Internet or a telephone line or may hold the programs for a certain time like a volatile memory in the computer system serving as a server and a client. The foregoing programs may realize a part of the above-mentioned functions or realize the function described above by the combination of the above-mentioned functions with the programs already recorded in the computer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing apparatus, comprising:
an acquisition section configured to acquire image data indicating a document;
a storage section configured to store characteristics of a plurality of colors containing a predetermined color;
a classifying section configured to classify a pixel contained in the image data acquired by the acquisition section based on the characteristics of the color stored in the storage section;
a deriving section configured to derive a statistic relating to the number of pixels classified into pixels of the predetermined color by the classifying section; and
a generation section configured to generate new image data obtained by correcting the predetermined color in the image data in a case in which it is determined that an image is formed with the predetermined color on the document based on the statistic derived by the deriving section.

2. The image processing apparatus according to claim 1, further comprising:
a determination section configured to determine a ground color of the document from the image data acquired by the data acquisition section, wherein
the classifying section is configured to classify pixels indicating colors different from the ground color of the document determined by the determination section by a plurality of colors.

3. The image processing apparatus according to claim 1, wherein
the statistic is a difference between the number of pixels classified into pixels of the predetermined color and the number of pixels classified into pixels of other colors, and
the generation section is configured to determine that the image is formed in the predetermined color on the document when the difference is equal to or greater than a predetermined threshold value, and to generate new image data obtained by correcting the predetermined color in the image data.

4. The image processing apparatus according to claim 2, wherein
the statistic is a difference between the number of pixels classified into pixels of the predetermined color and the number of pixels classified into pixels of other colors, and
the generation section is configured to determine that the image is formed in the predetermined color on the document when the difference is equal to or greater than a predetermined threshold value, and to generate new image data obtained by correcting the predetermined color in the image data.

5. The image processing apparatus according to claim 1, wherein
the predetermined color is a color that a decolorable color material develops.

6. The image processing apparatus according to claim 1, wherein the classifying section is configured to classify the pixel contained in the image data acquired by the acquisition section based in part on a luminance of the pixel.

7. A control method by an image processing apparatus provided with a storage section in which characteristics of a plurality of colors containing a predetermined color is stored, the method comprising:
acquiring image data indicating a document;
classifying a pixel contained in the acquired image data based on the characteristics of stored color in the storage section;
deriving a statistic relating to the number of pixels classified into pixels of the predetermined color; and
generating new image data obtained by correcting the predetermined color in the image data in a case in which it is determined that an image is formed with the predetermined color on the document based on the derived statistic.

8. The method according to claim 7, further comprising:
determining a ground color of the document from the acquired image data, wherein
the classifying comprises classifying pixels indicating colors different from the determined ground color of the document.

9. The method according to claim 7, wherein
the statistic is a difference between the number of pixels classified into pixels of the predetermined color and the number of pixels classified into pixels of other colors, and further comprising determining that the image is formed in the predetermined color on the document when the difference is equal to or greater than a predetermined threshold value, and generating new image data obtained by correcting the predetermined color in the image data.

10. The method according to claim 8, wherein
the statistic is a difference between the number of pixels classified into pixels of the predetermined color and the number of pixels classified into pixels of other colors, and further comprising:
determining that the image is formed in the predetermined color on the document when the difference is equal to or greater than a predetermined threshold value, and generating new image data obtained by correcting the predetermined color in the image data.

11. The method according to claim 7, wherein
the predetermined color is a color that a decolorable color material develops.
